(19) United States
(12) Patent Application Publication
(10) Pub. No.: US 2014/0312134 A1
(43) Pub. Date: Oct. 23, 2014

(54) MODULATED CYCLIC FLOW (MCF) DRIP IRRIGATION SYSTEMS

(71) Applicant: JAIN IRRIGATION SYSTEMS LIMITED, Bhambhori, Jalgaon (IN)

(72) Inventors: Michael Patrick DeFrank, Madera, CA (US); Stanley Edward Hawkins, Visalia, CA (US); Ajit Bhavarlal Jain, Bambhori (IN)

(21) Appl. No.: 14/357,439

(22) PCT Filed: Nov. 9, 2012
(86) PCT No.: PCT/IN2012/000741

§ 371 Date: May 9, 2014

(30) Foreign Application Priority Data
Nov. 9, 2011 (IN) 3164/MUM/2011

(51) Int. Cl. A01G 25/16; A01G 25/02

(52) U.S. Cl. CPC A01G 25/167; A01G 25/023
USPC 239/1; 239/63; 239/553

(57) ABSTRACT

The present system comprises, a MFC controller, emitter-lines that utilize non-drain technology on the emission devices and control valves for individual drip lines or groups of drip lines within an irrigation zone, along with a means to actuate the control valves by the controller. The MCF system utilizes a number of valves in an irrigation system to control either individual emitter-lines or groups of emitter-lines but does not control individual emitters. The present system has a programmable controller that has a number of stations, each of which controls a group of valves. Each station can be programmed for start time and duration that the station is actuated. Each station can be programmed independently from all the others allowing overlap or complimentary irrigation. The total input flow rate to the system remains nearly constant during a daily irrigation while the valve groups are cycling within the system.

### FIELD OF THE INVENTION

The present invention relates to a system and method for drip irrigation using modulated cyclic flow (hereinafter MCF) to achieve unprecedented flow rates and to optimize water usage for achieving higher crop yield. MCF is a system and method of controlling a drip irrigation system to provide lower average emission rates than the designed flow of existing emission devices.

### BACKGROUND OF THE INVENTION

Drip irrigation is widely accepted world-wide as a means to reduce water usage by delivering required amount of water directly to a plant's root zone. Drip irrigation systems have addressed the issues of plant growth by trying to achieve uniformity and accuracy in delivering exactly the same amount of water to each plant. Drip irrigation systems are non-variable within an irrigation block, delivering a fixed amount of water per hour when turned on to all plants within the block. The present day drip irrigation systems run once a day for periods of 4-12 hours during the peak need period. There is a “very wet” period while the system is running and a “drying down” period after the dripping has stopped. These wet/dry periods are far from optimum for the plant and reduce the yield.

Lower flow rate emitter lines are required to achieve delivery of water to meet the plant's requirement and retain the soil moisture level constant. In addition, since emitter lines have either a fixed output or a very narrow range of flow output, very low flow emitter lines are achieved that matches crop's peak use running 24 hours a day. Practically, it is difficult for such a system to provide required water and the crop may be deprived of ideal moisture just when it needs it the most. During periods of less than peak use, even this low flow system may only run for a limited time each day, resulting in the wet and dry soil moisture conditions that impede maximum production and quality.

The design of the emission pathways in the devices is restrictive with smaller dimensions that are required to achieve lower flow rates. However, the reduced pathway design results in increased clogging, and therefore there is need for much more sophisticated water filtering and treatment.

Thus there is a need to optimize drip irrigation systems to overcome aforementioned problems and limitations that the irrigation systems are currently facing in their effort to minimize water usage while maximizing crop yield quality and quantity.

### SUMMARY OF THE INVENTION

The present invention discloses a system and method to optimize drip irrigation by overcoming the aforementioned problems and limitations that the irrigation systems are currently facing in their effort to minimize water usage while maximizing yield quality and quantity.

The proposed system and method is termed as Modulated Cyclic Flow (MCF) and the present system comprises a MCF controller, emitter lines that utilize non-drain technology on emission devices and control valves for individual drip lines or groups of drip lines within an irrigation zone, along with a means to actuate the control valves by the controller.

Further, the MCF system utilizes a number of valves in an irrigation system to control either individual emitter lines or groups of emitter lines but does not control individual emitters. The MCF system further comprises of a programmable controller that has a number of stations, each of which controls a group of valves.

The present invention objects to achieve unprecedented flow rates and system control levels to optimize water usage and crop yield.

### OBJECTS OF THE INVENTION

1. It is the primary object of this invention to provide drip irrigation system which can achieve desired optimal moisture conditions for plant growth, quality and maximum yields during all phases of plant growth;
2. It is another object of invention to provide drip irrigation system with adjusting output in drip emitter line to maintain optimal soil moisture level;
3. It is another object of invention to selectively control the irrigation application rate at different parts of the irrigation block depending on soil factors; and
4. It is another object of invention to maintain ultra-low flow rates in emitter lines of drip irrigation system without clogging or increased filtration.

### BRIEF DESCRIPTION OF THE DRAWINGS

FIG. 1 is enlarged view of “MCF Irrigation System on soils with varied infiltration rates and hydraulic capacities” in accordance with an aspect of the present invention.

### DETAILED DESCRIPTION OF THE INVENTION

There are several factors which determine the yield of a crop in an agricultural field. These factors include soil and environment conditions under which the crop is grown. The first consideration is the soil that the crop is grown in. Soils are rarely uniform in physical structure, chemical properties and topography throughout a field. As a result, some areas of a field may have a lower infiltration rate, reduced water holding capacity, relative excess or deficiency of certain key chemical elements, slopes or low areas, sandy streaks, heavy clay, etc.

The second consideration is the environment that the crop is grown in. The environment changes with the season and within the day. The environment includes sun, wind, humidity, rainfall, cloud cover and temperature influence plant activity and cell expansion. The growth of a plant depends on the optimal levels of soil moisture and oxygen during the highest activity periods. Excessive moisture stress reduces yield and quality of the crop. Excessive soil moisture can also result in reduced levels of oxygen available to the root system, reduced availability of certain key nutrients and the promotion of pathogenic organisms. All of these problems can reduce yield and quality of the crop.

The present invention uses modulated cyclic flow (hereinafter referred to as MCF) involved in feeding a drip emitter line with cyclic flow instead of a continuous flow. Modulated Cyclic Flow is a system and method of controlling drip irrigation to provide lower average emission rates than the design flow of the emission devices. Lower emission rates allow longer duration daily irrigation to more closely match daily consumptive use of water by a crop. Lower emission rates prevent localized flooding of the root zone, run-off and driving water below the root zone. The present system comprises, a MFC controller, emitter-lines that utilize non-drain technology on the emission devices and control valves for individual drip lines or groups of drip lines within an irrigation zone, along with a means to actuate the control valves by the controller.

The MCF system utilizes a number of valves in an irrigation system to control either individual emitter-lines or groups of emitter-lines but does not control individual emitters. The present system and method also proposes that many of these valves operate simultaneously while other valves are OFF. It also maintains the relative balance of valves being ON and OFF as irrigation demand increases or decreases. The present system has a programmable controller that has a number of stations, each of which controls a group of valves. Each station can be programmed for start time and duration that the station is actuated. Within this duration, the station can be programmed for the valve group cycle on-time duration and off-time duration. Each station can be programmed independently from all the others allowing overlap or complimentary irrigation. The total input flow rate to the system remains nearly constant during a daily irrigation while the valve groups are cycling within the system.

The first key element is the use of emitter-lines having non-draining or “non-leak” emission devices. In prior art drip emitter lines were designed in drip irrigation system to provide continuous flow of liquid to the irrigation block. Drip emitters are limited by their design with regards to emitting at ultra-low flow rates. Once an emitter line is in place in a field, the flow rate is pretty much set. It is observed that the design of the emission pathways with smaller dimensions is used to obtain lower flow rates. Therefore, emitter line cannot deal with optimizing application rate over a 24 hour period to match plant needs. The present invention discloses a drip irrigation system wherein variable flow rates are possible. The system uses flexible adjusting output in the drip emitter line so that output matches plant uptake to maintain the optimal soil moisture level when used on a 24 hour a day basis. When this occurs, the controller determines coordination of the valves to provide a non-cyclic input flow requirement.

For example: During peak use it may be that all valves are on for maximum flow. As demand falls, the valves may be cycled in 4 minute intervals to achieve 75% of maximum flow. This would be done by dividing the valves into four equal sized flow groups. At first, group numbers 1, 2 and 3 would be ON while number 4 would be OFF. Then group 1 would turn OFF and number 4 would turn ON. As the sequence continues, each valve group would be on 75% of the total time. As demand continues to fall, the valves would be divided into two groups to achieve 50% of maximum flow. Group number 1 would be ON while number 2 would be OFF. Then group 1 would be turned OFF and group 2 turned ON. As demand further falls, the valves would be divided into four groups to provide 25% of maximum flow. Group number 1 would be ON while numbers 2, 3 and 4 would be OFF. Then group 1 would turn OFF and number 2 would turn ON. In this case, each valve group would end up being on 25% of the time. Similarly, any flow rate or water requirement can be realized by manipulating the cycling frequency and valve grouping. The emitter-lines are shut OFF completely at pressures lower than the normal operating pressure.

For example, if the operating pressure of the emitter line ranges from 10-50 psi, then emitter-line may shut off when the pressure drops to 6 psi. When an emitter-line is turned OFF, as the pressure drops, the emission devices seal and retain water in the line at 6 psi. This is done so that the emitter-line cannot drain out when it is turned OFF.

If the field has any slope or is even slightly undulating, the water in an emitter-line without the non-drain feature will drain to the lowest portion of the emitter-line. In addition, when such an emitter-line is turned back ON, it will take some time to fill from beginning to end with the first emission devices in the line emitting water before the last emitters. Both of these conditions induce non-uniformity to the irrigation cycle, in spite of individual emission device accuracy and uniformity. The present invention the emitter-line uses a cyclic manner to reduce flow rate in order to match crop needs and thus induced non-uniformity is magnified as these cycles are short in duration.

The second key element is a control system, including a controller, wiring and valves to enable each emitter-line or small group of emitter-lines to control emitter-line independently and the ability to modulate the cycling ON/OFF ratio. The controller used for MCF drip irrigation systems would be pre-programmed for the specific valve groups to be used for each flow rate desired. In addition, if there are portions of the irrigation block that have a different application rate requirement, due to soil factors, the valves serving these areas would also be subdivided into specific cycling groups to provide the necessary flow rates. These areas would follow a cycling rate that would be specific to the common soil factors. When the controller is instructed to increase or decrease flow to the irrigation block, it will be able to set up the appropriate valve groups and cycle them to achieve the flow rates desired. The cycling frequency is set at high level and is having a time scale in minutes. The cycling frequency and ON/OFF times would be variable. The use of variable cycling frequency means overall effective frequency can be achieved using a single type of emitter. For example, a 0.25 gph effective flow rate can be attained by cycling a 0.5 gph emitter-line with a 1 minute ON/1 minute OFF frequency. Since the actual emitter is still 0.5 gph, there is no increased chance of clogging or a need for a better filtration system. In addition, the controller must continuously monitor the overall flow rate into the system by coordinating the ON/OFF cycles so that the whole system does not cycle.

The third key element is a variable flow, constant pressure water supply. Since the MCF system will be delivering a water flow rater according to plant requirements and well as the differential requirements of the soil factor present, water demand will vary greatly through a 24 hour period. Constant pressure variable flow water supplies are available in typical municipal systems. In agricultural applications, where water is coming from a well, reservoir or canal, variable flow pumps such as pumps with variable frequency drive motors would be required. The MCF system for irrigation meets the requirement for irrigating some parts of an irrigation block at a different flow rate than others based on the soil factor. This is accomplished by having line by line control of irrigation within the irrigation block so that some areas may be cycle irrigated differently than others. The layout of the irrigation system must be designed so that soil factor areas can be irrigated with emitter-lines wholly contained within that area. MCF deals with the wet/dry periods since the frequency of the cycling can be controlled based on the plants' optimum water requirement. The frequency scale is high enough to make wet/dry periods between cycles negligible. Also, as the system runs over a long period of time, the overall flow rate for the plants is also optimized.

MCF is also equipped to have the flow rate of the system change over time through variable adjustment to the cycling frequency. By modulating the cycling ratio to reduce or increase the percentage on time, MCF can deliver extremely low emitter-line flow rates all the way up to full flow rate to match plant requirements throughout the day and night.

The modulated cyclic flow (MCF) is explained in detail with reference to the accompanying drawing in accordance with an embodiment of the present invention.

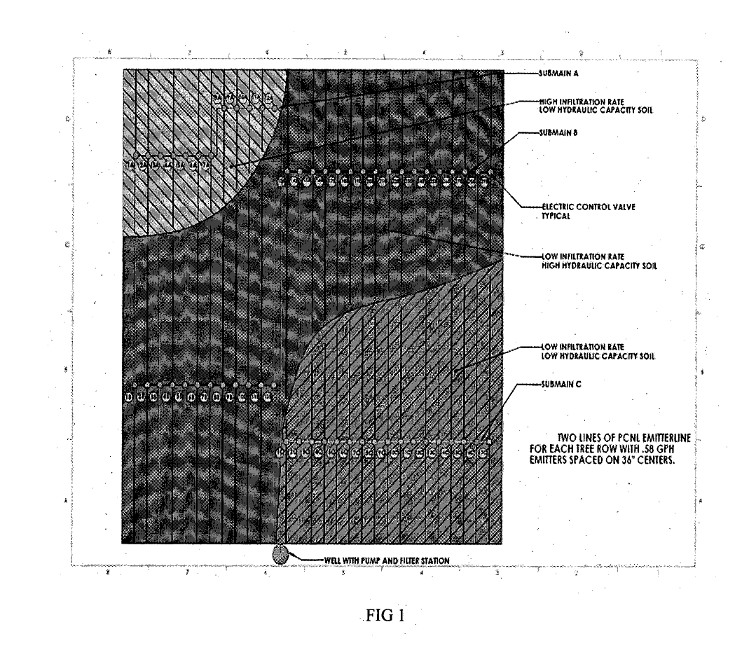

FIG. 1 illustrates a layout of 10 acre almond MCF irrigation system on soils with varied infiltration rates and hydraulic capacities”. In this field, the soil characteristics are three dimensionally mapped to enable the proper design and operation of the MCF drip irrigation system and the field is not uniform in soil characteristics. The field can be classified into irrigation zones for proper irrigation management and control within each zone.

The crop being grown under this system is almonds and the irrigation system has two lines of PCNL emitter-line for each tree row with 0.58 gph emitters spaced on 36″ centers. The peak consumptive use in this location is 0.32″ per day during the month of July. The row spacing is 20′ and the tree spacing in the row is 16′.

Zone A has soil that has a high infiltration rate and low hydraulic capacity. The soil could be a sandy soil with a sandy subsoil or sandy loam shallow subsoil. The soil must be irrigated frequently but with a fairly high application rate to increase the diameter of surface wetting and the total root zone volume. The on-time must be of fairly short duration so as not to drive the water below the root zone. Zone A has 12 electric control valves, one for each tree row's two emitter-lines. These valves will be segregated into four valve groups of 3 valves each with each set of 3 valves to have equal or nearly equal flow rates. As the first group is shut off, the next group will come on and the input flow will remain relatively constant. This will allow this zone to be irrigated with an average emission rate as low as 25% of the normal emitter flow rate.

Zone B has a soil that has a low infiltration rate and high hydraulic capacity. The soil could be a clay or clay loam surface soil with similar subsoil. The soil must be irrigated slowly to get the water into the soil without standing or running off and also must be irrigated slowly and fully at the beginning of the irrigation season to fill the root zone to capacity. Zone B has 29 electric control valves, one for each tree row's two emitter-lines. These valves will be segregated into four valve groups of either 7 or 8 valves each with valves selected to give equal or nearly equal flow rates for each group. As the first group is shut off, the next group will come on and the input flow will remain relatively constant. This will allow this zone to be irrigated with an average emission rate as low as of 25% of the normal emitter flow rate.

Zone C has a soil that has a low infiltration rate with a low hydraulic capacity. The soil could be a sandy clay loam surface soil over a loamy sand shallow subsurface soil. The soil must be irrigated slowly to prevent run-off and frequently to maintain adequate moisture in the root zone. Zone C has 18 electric control valves, one for each tree row's two emitter-lines. These valves will be segregated into four valve groups with either 4 or 5 valves in a group with valves selected to give equal or nearly equal flow rates for each group. Either one or two valve groups will come on at a time. As the first group is shut off, the next group will come on and the input flow will remain relatively constant. This will allow this zone to be irrigated and average emission rate as low as of 25% of the normal emitter flow rate.

### Zone Specific Programming:

Zone A has a soil with a high infiltration rate and low water holding capacity, it would be advantageous to irrigate it with a longer on-time duration cycle. This would help increase the wetted diameter at the surface and also increase the wetted soil volume. The valve groups in Zone a will be programmed with a 24 minute cycle on time duration.

Zones B and C have soils with low infiltration rates so short duration cycles are needed. These valve groups would be programmed for a 6 minute cycle on time duration.

The MCF controller is programmed to deliver a 25% average emission rate 10.4 hour (768 min) duration 0.10″ application and is illustrated in Table 1.

TABLE 1

| STA- | STATION | TIME, MINUTES | | | | | | | | | | | | | | | | |
|---|---|---|---|---|---|---|---|---|---|---|---|---|---|---|---|---|---|---|
| TIONS | PROGRAMS | 0 | 6 | 12 | 18 | 24 | 32 | 36 | 42 | 48 | 54 | 60 | 66 | 72 | 78 | 84 | 90 | 96 |
| Station 1 Valve Group 1 (1A-7A- 12A) | Start time: 0 Duration: 768 min Cycle on duration: 24 min Cycle off duration: 72 min | 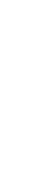 | 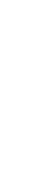 | 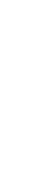 | 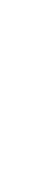 | | | | | | | | | | | | | |
| Station 2 Valve Group 2 (2A-8A- 11A) | Start time: 24 Duration: 768 min Cycle on duration: 24 min Cycle off duration: 72 min | | | | | 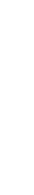 | 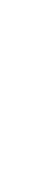 | 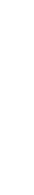 | 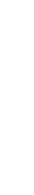 | | | | | | | | | |
| Station 3 Valve Group 3 (3A-6A- 10A) | Start time: 48 Duration: 768 min Cycle on duration: 24 min Cycle off duration: 72 min | | | | | | | | | 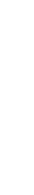 | 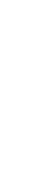 | 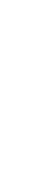 | 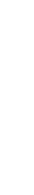 | | | | | |
| Station 4 Valve Group 4 (4A-5A- 9A) | Start time: 72 Duration: 768 min Cycle on duration: 24 min Cycle off duration: 72 min | | | | | | | | | | | | | 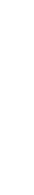 | 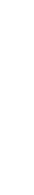 | 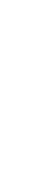 | 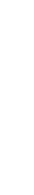 | |
| Station 5 Valve Group 5 (1B-7B) | Start time: 0 Duration: 768 min Cycle on duration: 6 min Cycle off duration: 18 min | 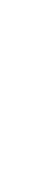 | | | | 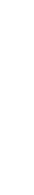 | | | | 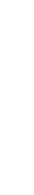 | | | | 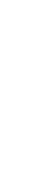 | | | | |
| Station 6 Valve Group 6 (8B- 14B) | Start time: 6 Duration: 768 min Cycle on duration: 6 min Cycle off duration: 18 min | | 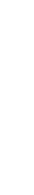 | | | | 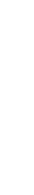 | | | | 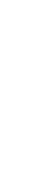 | | | | 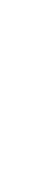 | | | |
| Station 7 Valve Group 7 (15B- 21B) | Start time: 12 Duration: 768 min Cycle on duration: 6 min Cycle off duration: 18 min | | | 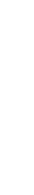 | | | | 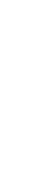 | | | | 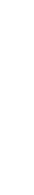 | | | | 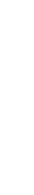 | | |
| Station 8 Valve Group 8 (22B- 29B) | Start time: 18 Duration: 768 min Cycle on duration: 6 min Cycle off duration: 18 min | | | | 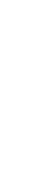 | | | | 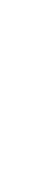 | | | | 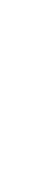 | | | | 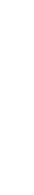 | |
| Station 9 Valve Group 9 (1C-2C- 3C-9C- 10C) | Start time: 0 Duration: 768 min Cycle on duration: 6 min Cycle off duration: 18 min | 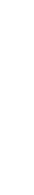 | | | | 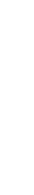 | | | | 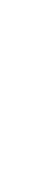 | | | | 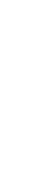 | | | | |
| Station 10 Valve Group 10 (11C-12C- 17C-18C) | Start time: 6 Duration: 768 min Cycle on duration: 6 min Cycle off duration: 18 min | | 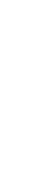 | | | | 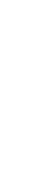 | | | | 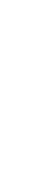 | | | | 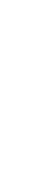 | | | |
| Station 11 Valve Group 11 (13C-14C- 15C-16C) | Start time: 12 Duration: 768 min Cycle on duration: 6 min Cycle off duration: 18 min | | | 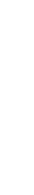 | | | | 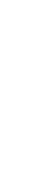 | | | | 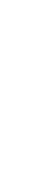 | | | | 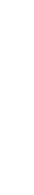 | | |
| Station 12 Valve Group 12 (4C-5C- 6C-7C- 8C) | Start time: 18 Duration: 768 min Cycle on duration: 6 min Cycle off duration: 18 min | | | | 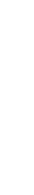 | | | | 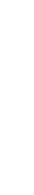 | | | | 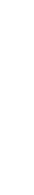 | | | | 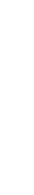 | |

Also, the MCF controller is programmed to deliver a 50% average emission rate 10.4 hour (624 min) duration 0.32″ application and is illustrated in Table 2.

TABLE 2

| | STATION | TIME, MINUTES | | | | | | | | | | | | | | | | |
|---|---|---|---|---|---|---|---|---|---|---|---|---|---|---|---|---|---|---|
| STATIONS | PROGRAMS | 0 | 6 | 12 | 18 | 24 | 32 | 36 | 42 | 48 | 54 | 60 | 66 | 72 | 78 | 84 | 90 | 96 |
| Station 1 Valve Group 1 (1A-7A-12A) | Start time: 0 Duration: 62 min Cycle on duration: 24 min Cycle off duration: 24 min | 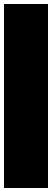 | 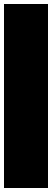 | 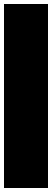 | 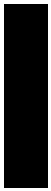 | | | | | 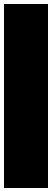 | 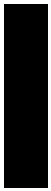 | 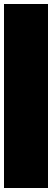 | 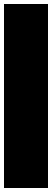 | | | | | |
| Station 2 Valve Group 2 (2A-8A-11A) | Start time: 0 Duration: 624 min Cycle on duration: 24 min Cycle off duration: 24 min | 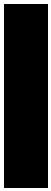 | 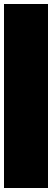 | 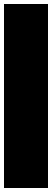 | 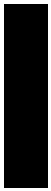 | | | | | 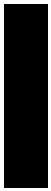 | 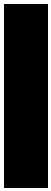 | 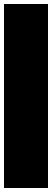 | 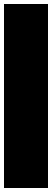 | | | | | |
| Station 3 Valve Group 3 (3A-6A-10A) | Start time: 24 Duration: 624 min Cycle on duration: 24 min Cycle off duration: 24 min | | | | | 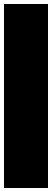 | 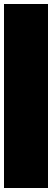 | 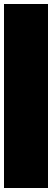 | 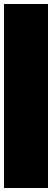 | | | | | 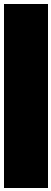 | 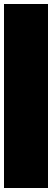 | 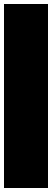 | 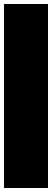 | |
| Station 4 Valve Group 4 (4A-5A-9A) | Start time: 24 Duration: 624 min Cycle on duration: 24 min Cycle off duration: 24 min | | | | | 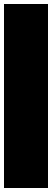 | 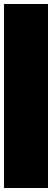 | 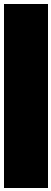 | 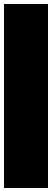 | | | | | 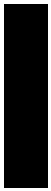 | 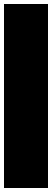 | 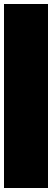 | 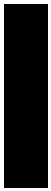 | |
| Station 5 Valve Group 5 (1B-7B) | Start time: 0 Duration: 624 min Cycle on duration: 6 min Cycle off duration: 6 min | 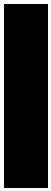 | | 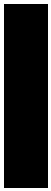 | | 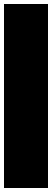 | | 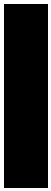 | | 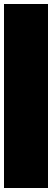 | | 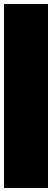 | | 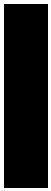 | | 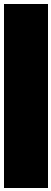 | | |
| Station 6 Valve Group 6 (8B-14B) | Start time: 0 Duration: 624 min Cycle on duration: 6 min Cycle off duration: 6 min | 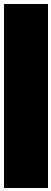 | | 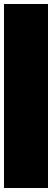 | | 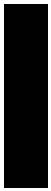 | | 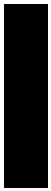 | | 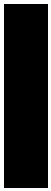 | | 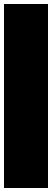 | | 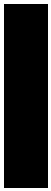 | | 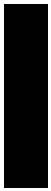 | | |
| Station 7 Valve Group 7 (15B-21B) | Start time: 6 Duration: 624 min Cycle on duration: 6 min Cycle off duration: 6 min | | 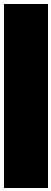 | | 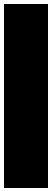 | | 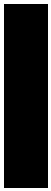 | | 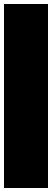 | | 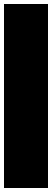 | | 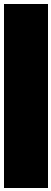 | | 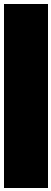 | | 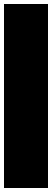 | |
| Station 8 Valve Group 8 (22B-29B) | Start Time: 6 Duration: 624 min Cycle on duration: 6 min Cycle off duration: 6 min | | 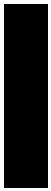 | | 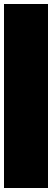 | | 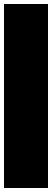 | | 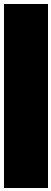 | | 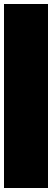 | | 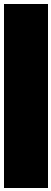 | | 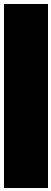 | | 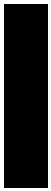 | |
| Station 9 Valve Group 9 (1C-2C-3C-9C-10C) | Start time: 0 Duration: 624 min Cycle on duration: 6 min Cycle off duration: 6 min | 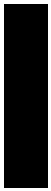 | | 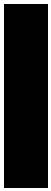 | | 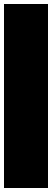 | | 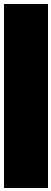 | | 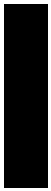 | | 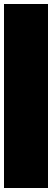 | | 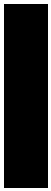 | | 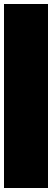 | | |
| Station 10 Valve Group 10 (11C-12C-17C-18C) | Start time: 0 Duration: 624 min Cycle on duration: 6 min Cycle off duration: 6 min | 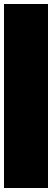 | | 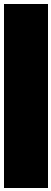 | | 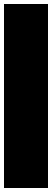 | | 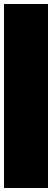 | | 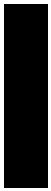 | | 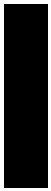 | | 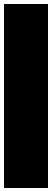 | | 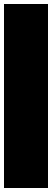 | | |
| Station 11 Valve Group 11 (13C-14C-15C-16C) | Start time: 6 Duration: 624 min Cycle on duration: 6 min Cycle off duration: 6 min | | 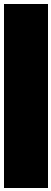 | | 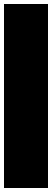 | | 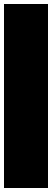 | | 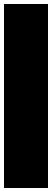 | | 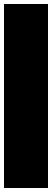 | | 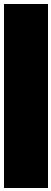 | | 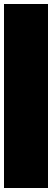 | | 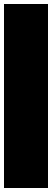 | |
| Station 12 Valve Group 12 (4C-5C-6C-7C-8C) | Start time: 6 Duration: 624 min Cycle on duration: 6 min Cycle off duration: 6 min | | 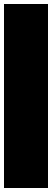 | | 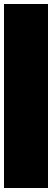 | | 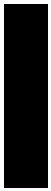 | | 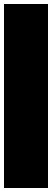 | | 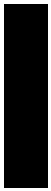 | | 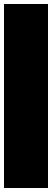 | | 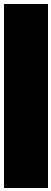 | | 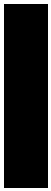 | |

The valve groups in each station are wired by four control wires, one for each group of valves in the station. Once selected these groups do not change: The selection of valves is made so that each of the four groups in a zone has approximately the same flow rate. This assures that the overall flow rate of the zone does not change significantly as the stations go through their cycle.

Throughout the year, the irrigation needs of the crop will vary. During spring and leading to summer months, the need will increase and become greatest in July and then taper off again as fall approaches. Modulated Cyclic Flow drip irrigation will allow longer daily duration, lower average emission rates throughout the irrigation season. This is advantageous to the crop as it will maximize the soil wetted volume where roots can become established and make it easier to maintain the proper air/water balance in the critical feeder root area. By assuring the largest root volume with moisture levels continuously maintained at the optimum level, regardless of soil type, crop yields can be maximized.

For example, in March and April, the irrigation system may be operated with a cyclic flow emission rate of 25%. In our example system, this flow rate would provide 0.19″ in a 24 hour period. The system may start the season running 12 hours per day delivering about 0.10″ per day. As the needs increase, the duration of irrigation every day may increase to 24 hours.

In May and June, the irrigation system may be operated with a cyclic flow emission rate of 50%. The MCF controller would program two valve groups in a sub main to come on at a time and shut down while the next two groups come on. In this way, a valve group has an average emission rate of 50%. In an embodiment of the present system, this flow rate would provide 0.37″ in a 24 hour period. In May, the system my run 12 hours per day delivering about 0.19″ per day. As the needs increase, the duration of irrigation every day may increase to 21 hours. At this duration, 0.32″ per day would be delivered.

In August and September, the duration of irrigation using a 50% emission rate would be reduced down to 12 hours per day. In September and October, the MFC controller would go back to program one valve group to come on at a time for a 25% emission rate, with the duration as needed.

In conclusion, the present invention provides drip irrigation system which can achieve desired optimal moisture conditions for plant growth, quality and maximums yields during all phases of plant growth.

We claim:

1. A modulated cyclic flow (MCF) drip irrigation system, comprising:
a. a programmable controller capable of controlling a plurality of emitter line control valves;
b. a feedback control system capable of providing feedback for measuring soil moisture;
c. a plurality of emitter lines characterized by said plurality of emitter control valves;
d. a means to actuate a plurality of emitter line control valves by said controller; and
e. a water pumping system and a filtration system.

2. The modulated cyclic flow (MCF) drip irrigation system as claimed in claim 1, wherein said programmable controller comprises of a plurality of stations wherein each station controls a group of said emitter line control valves.

3. The modulated cyclic flow (MCF) drip irrigation system as claimed in claim 2, wherein said programmable controller and said communication system turns each of said emitter line valves ON or OFF individually.

4. The modulated cyclic flow (MCF) drip irrigation system as claimed in claim 1, wherein said feedback control system provides feedback for measuring soil moisture.

5. The modulated cyclic flow (MCF) drip irrigation system as claimed in claim 4, wherein said programmable controller and said communication system are programmed and updated continuously.

6. The modulated cyclic flow (MCF) drip irrigation system as claimed in claim 1, wherein said emitter lines comprises of non-draining or non-leak emission devices.

7. The modulated cyclic flow (MCF) drip irrigation system as claimed in claim 6, wherein said non-leak emission devices fully accommodate water on said emitter lines at pressure just below operating range of said emission devices.

8. The modulated cyclic flow (MCF) drip irrigation system as claimed in claim 1, wherein said system utilizes a flexible adjusting output in said emitter lines wherein said output matches plant intake to maintain soil moisture level.

9. The modulated cyclic flow (MCF) drip irrigation system as claimed in claim 8, wherein said controller determines coordination of said valves wherein said valves provide a non-cyclic input flow.

10. The modulated cyclic flow (MCF) drip irrigation system as claimed in claim 1, wherein a plurality of emitter line actuating valves are remotely operated to turn said emitter lines ON or OFF.

11. The modulated cyclic flow (MCF) drip irrigation system as claimed in claim 10, wherein an actuator is provided for powering said emitter line actuating valves.

12. The modulated cyclic flow (MCF) drip irrigation system as claimed in claim 11, wherein said emitter line valves are turned ON or OFF individually wherein required amount of water is delivered along said emitter line to maintain optimum moisture conditions.

13. The modulated cyclic flow (MCF) drip irrigation system as claimed in claim 1, wherein said pumping system maintains constant pressure with varying flow rates and a filtration system is provided for said non-leak emission devices.

14. A method of irrigating by above said modulated cyclic flow (MCF) drip irrigation system, comprise of:
a. controlling an individual emitter lines or a plurality of emitter lines using a plurality of valves; and
b. providing feedback to an control system;

15. The method of irrigating as claimed in claim 14, wherein said valves are ON for maximum flow during peak use.

16. The method of irrigating as claimed in claim 15, wherein said valves are cycled in 4 minute intervals to achieve 75% of said maximum flow when demand of water is less.

17. The method of irrigating as claimed in claim 16, wherein said valves are divided into 4 equal sized flow groups.

18. The method of irrigating as claimed in claim 17, wherein said groups 1, 2, and 3 is ON while said group 4 is OFF then said group 1 is turned OFF while said group 4 is turned ON.

19. The method of irrigating as claimed in claim 14, wherein said valves are divided into 2 groups to achieve 50% of said maximum flow when demand of water continues.

20. The method of irrigating as claimed in claim 19, wherein said group 1 is ON while group 2 is OFF then group 1 is OFF while group 2 is ON.

21. The method of irrigating as claimed in claim 14, wherein said valves are divided into 4 groups to provide 25% of said maximum flow when demand of water further continues.

22. The method of irrigating as claimed in claim 21, wherein said group 1 is ON while group 2, 3 and 4 are OFF then group 1 is OFF while group 2, 3 and 4 are ON.

23. The method of irrigating as claimed in claim 14, wherein said valve groups and cyclic frequency can be manipulated for any desired flow rate or water requirement.

24. The method of irrigating as claimed in claim 14, wherein said control system is programmed and updated continuously with respect to said feedback.
